(19) United States
(12) Patent Application Publication
(10) Pub. No.: US 2024/0269661 A1
(43) Pub. Date: Aug. 15, 2024

(54) PHOTOSENSITIVE PARTICLE AND ITS PRODUCTION, OXYGEN-GENERATING UNIT AND USES OF SAME

(71) Applicant: Jassen-Kunststoffzentrum GmbH--Apparatebau, Zuschnitte und Formung, Steinen (DE)

(72) Inventors: Marco ILLENBERGER, Freiburg (DE); Bernhard ILLENBERGER, Steinen (DE); Hartmut JASSEN, Steinen (DE)

(73) Assignee: Jassen-Kunststoffzentrum GmbH--Apparatebau, Zuschnitte und Formung, Steinen (DE)

(21) Appl. No.: 18/568,081

(22) PCT Filed: Jun. 8, 2022
(86) PCT No.: PCT/EP2022/065579

§ 371 Date: Mar. 20, 2024

(30) Foreign Application Priority Data
Jun. 8, 2021 (DE) 10 2021 114 704.2

(51) Int. Cl. B01J 35/39; B01J 21/16; B01J 31/06; B01J 35/40; B01J 37/00; B01J 37/02; B01J 37/04; C01B 13/02; C01B 15/027; C25B 1/27

(52) U.S. Cl. CPC B01J 35/39; B01J 21/16; B01J 31/06; B01J 35/40; B01J 37/0036; B01J 37/0219; B01J 37/0236; B01J 37/04; C01B 13/02; C01B 15/027; C25B 1/27

(57) ABSTRACT

A photosensitive particle (25) having a carrier element (27) to which a material (29) is adhered by an adhesive (28), the material (29) containing light-active dye molecules (30). A plurality of such photosensitive particles (25) can be arranged in a photo-electric cell (22) of an oxygen-generating unit (21).

### CROSS-REFERENCE TO RELATED APPLICATIONS

This application is a 371 National Phase of International Application No. PCT/EP2022/065579, filed Jun. 8, 2022, which claims priority from German Patent Application No. 10 2021 114 704.2, filed Jun. 8, 2021, both of which are incorporated herein by reference as if fully set forth.

### TECHNICAL FIELD

The invention relates to a photosensitive particle, a method for producing such photosensitive particles, an oxygen-generating unit, and uses of such an oxygen-generating unit.

### BACKGROUND

Oxygen is required in practice in many applications. This can be provided in the form of molecular oxygen in the gaseous state or in the state dissolved in water. Alternatively, oxygen is bound to hydrogen in the form of water H2O or in the concentrated form of hydrogen peroxide (H2O2). The production of oxygen is energy-intensive and environmentally harmful.

### SUMMARY

The invention is based on the object of providing oxygen in an environmentally-protective, sustainable manner.

To achieve this object, the invention proposes photosensitive particles according to one or more of the features disclosed herein. In particular, it is thus proposed according to the invention in a photosensitive particle that it has a carrier element to which a material adheres by means of an adhesive, wherein the material contains light-active pigment molecules.

The material preferably comprises a nonliving, in particular dead organic substance. The material particularly preferably comprises a humus component and/or a clay mineral. Very particularly preferably, the material comprises plant leaf polymers. These can be provided from plant leaf material. It has been shown that the plant leaf polymers of dead and dropped autumn leaves are outstandingly suitable.

The light-active pigment molecules can be excited by corresponding irradiated light. This can have the result that electrons and protons are transferred to neighboring molecules. If the neighboring molecule is molecular hydrogen, this can have the result that hydrogen peroxide is formed. If the pigment molecules are incorporated in a humic substance-clay mineral complex, radicals can be generated. For example, a radical generated as a hyperoxide anion can trigger a proton transfer to a transition metal such as iron or copper, which are incorporated in the humic substance-clay mineral complex, by which molecular oxygen can be split off from the humic substance-clay mineral complex, which can then be converted into hydrogen peroxide. As a result, with the aid of the photosensitive particles and the oxygen-generating unit described in more detail hereinafter, hydrogen peroxide and molecular oxygen which can be dissolved in water can be generated. Therefore, oxygen can be provided in an environmentally-protective, sustainable manner using the photosensitive particles.

The sustainability can be further improved if in an advantageous embodiment of the photosensitive particle it is provided that the light-active pigment molecules are sensitive in the spectrum of sunlight, preferably in the visible range of the spectrum of sunlight. Pigment molecules are sensitive to light of a specific wavelength if they are able to absorb the energy of the light of this wavelength in that they are excited, for example. The absorbed energy can then be emitted again in another form. For example, plant pigments have conjugated double bonds, thus alternating double and single bonds, the pi electrons of which can be excited by light. A corresponding artificial light source can be designed. Alternatively, however, the sun can also be used as a light source. The above-mentioned plant leaf material, which comprises light-active pigment molecules in visible light, fulfills this property.

The carrier element preferably has a maximum diameter of 1 cm, more preferably between 100 μm and 0.5 cm, particularly preferably between 0.5 mm and 3 mm, very particularly preferably between 1 mm and 2 mm.

The carrier element can have any shape in principle, a spherical shape is preferred.

The carrier element is preferably made of a plastic. The carrier element is preferably a microplastic particle. The microplastic particle can be manufactured from primary or secondary plastic.

It can be provided that the adhesive comprises a mucilage. The mucilage preferably contains a polysaccharide. The mucilage can be a mucin. The mucilage can be human, animal, or plant mucus. The mucilage can also be a saliva substitute product such as hyaluronic acid.

It is preferably provided that the adhesive envelops the carrier element.

As already described above, the material preferably comprises a nonliving, in particular dead organic substance. The material can in particular comprise a humus component and/or a clay mineral. The humus component is preferably a humic substance. Clay minerals can form particularly advantageous complexes with humic substances.

A clay mineral is preferably a mineral having an average grain size less than 5 μm, preferably less than 2 μm.

Humus can have a high density of light-active pigment molecules in suitable layers. Layers in which the humus additionally has a high proportion of lignin and polyphenol fragments and light-active pigment molecules integrated therein are suitable for the invention.

It has proven to be particularly advantageous if the material comprises plant leaf polymers. The plant leaf polymer of the aged, in particular shed in the autumn months of September and October, dropped, and dead leaves of deciduous trees form a particularly advantageous structure. The plant leaf polymer of plants in the plant family dicotyledonous angiosperms is particularly advantageous, in particular having a cellulose proportion of 15-50%, hemicellulose proportion of 3-50%, and/or lignin proportion of 7-10%. The plant leaf polymer of the dead leaves of deciduous trees can have a high concentration of different pigment molecules.

The photosensitive particles are particularly preferably those which are produced by the method described hereinafter.

To achieve the stated object, according to the invention the features of the further independent claim directed to a method for producing a photosensitive particle are provided. In particular, to achieve the stated object, a method for producing a photosensitive particle is proposed according to the invention, in which it is provided that a material is applied to a carrier element by means of an adhesive, wherein the material contains light-active pigment molecules. An adhesive bond is therefore produced between the material and the carrier element by the adhesive. The application can take place, for example, in that the carrier element is enveloped by the material or the carrier element is embedded in the material. This can be performed, for example, by mixing the material, the adhesive, and the carrier element. In this way, a photosensitive particle can be produced which is designed according to the invention, in particular as described above and/or according to one of the claims directed to a photosensitive particle. A large number of such photosensitive particles are preferably produced at the same time using this method. For this purpose, for example, a large number of carrier elements can be mixed with the material and the adhesive.

The carrier element, the adhesive, and the material can be designed as described above.

The carrier element can preferably be produced in that macroplastic, which can originate, for example, from plastic granules, plastic discard parts, or plastic waste, is pulverized, for example by shredders and/or by means of a cryogenic vibrating cup mill. The carrier element can in particular be pulverized to particles with diameters as mentioned above in this way.

A mucilage as an adhesive can be produced by taking human, animal, or plant mucus or by chemically producing the mucilage. For example, a viscous mixture results by adding sodium tetraborate solution (Na2B4O7) to a polyvinyl alcohol solution (C2H4O). The condensation reaction results in cross-linking of the polyvinyl chains and the stage of the cross-linking and the formation of the viscosity may be adjusted and result in a (borax) slime.

The material which contains the light-active pigment molecules can be obtained, for example, by isolating and/or providing nonliving, in particular dead organic substance. Plant leaf polymer, preferably from autumn leaves or from leaves as described above, is preferably provided. Particularly preferably, its plant pigment proportion is at least 1% and/or its lignin mass proportion is greater than 1% in dry substance and/or its mass proportion of a chlorophyll degradation product non-fluorescent chlorophyll catabolites (NCC) is between 0.6% to 1.2% in dry substance of the total proportion of the plant leaf material.

The provided plant leaf polymer is preferably dried, preferably until a water mass proportion of the plant leaf material of at most 25%, in particular at most 20%, at most 10%, or at most 5% is reached.

The dried plant leaf material is preferably pulverized. The plant material is particularly preferably pulverized to particle sizes between 0.01 mm and 2 mm, in particular between 0.1 mm and 1 mm.

The plant leaf material, in particular the dried and/or pulverized plant leaf material, is preferably mixed with clay minerals. The mass proportion of the plant leaf material is preferably between 60% and 99%, the mass proportion of the clay minerals is between 1% and 20%, and the mass proportion of water and/or the mass proportion of a further material is between 0% and 20%. The mass proportions relate to the mixture, which has a mass proportion of 100%.

It can be provided that the material containing the light-active pigment molecules is mixed with the adhesive. The material preferably has a mass proportion between 80% and 99%, the adhesive has a mass proportion between 1% and 10%. Furthermore, water can be admixed with a mass proportion between 0% and 10%. Overall, the above-mentioned mass proportions are each related to a mass of the mixture, which has a mass proportion of 100%.

It can be provided that this material-adhesive mixture is then mixed with the carrier elements, for example by adding these to the material-adhesive mixture and by then mixing the material-adhesive mixture. The carrier elements can be enveloped by the adhesive in this way. The viscosity of the adhesive and/or the volume ratio of the carrier elements to the material-adhesive mixture are preferably adjusted during the mixing so that the outer surface of the envelope is at most 10%, preferably at most 5%, larger than the surface of the enveloped carrier element.

To achieve the mentioned object, according to the invention the features of the further independent claim directed to an oxygen-generating unit are provided. In particular, to achieve the mentioned object, an oxygen-generating unit is therefore proposed according to the invention in which it is provided that it comprises a photocell, in which a large number of photosensitive particles are arranged, wherein the photosensitive particles are each formed according to the invention, in particular as described above and/or according to one of the claims directed to a photosensitive particle. It has already been described above that usable oxygen can be produced in an environmentally-friendly and sustainable manner using such an oxygen-generating unit.

The photocell preferably has a hollow body having a transparent wall. The photocell, in particular the above-mentioned wall, is particularly preferably transparent in visible light and/or in the spectrum of sunlight.

To improve the effectivity of the oxygen generation, it can be provided that the photosensitive particles are suspended in a photocell liquid. The photocell liquid preferably contains water, wherein the water proportion can also be 100%.

To improve the generation of oxygen, it can be provided in a refinement of the oxygen-generating unit that it has an oxygen-generating circuit for the photocell liquid, wherein the photocell is incorporated in the oxygen-generating circuit. Circulating photocell liquid therefore also flows through the photocell. The photocell therefore preferably has an inlet and an outlet for the photocell liquid. A pump can be arranged in the oxygen-generating circuit. The pump can cause the required drive for the circulation of the photocell liquid in the oxygen-generating circuit. The oxygen-generating circuit furthermore preferably comprises at least one line, through which the photocell liquid can circulate.

It can be provided that the oxygen-generating unit has a tank connected to the oxygen-generating circuit, using which photocell liquid can be fed into the oxygen-generating circuit. The tank can be filled with photocell liquid, in particular with water. Alternatively or additionally, it can be provided that the oxygen-generating unit has a discharge line connected to the oxygen-generating circuit, via which photocell liquid can be discharged. The photocell liquid can be conducted, for example, via the discharge line into a further tank or can be conducted directly to a recipient. For this purpose, the discharge line can be connected to a corresponding inlet of the recipient. The recipient can be, for example, the bioreactor mentioned hereinafter or the device mentioned hereinafter for converting ammonia from an aqueous liquid containing ammonia into molecular nitrogen. These are only exemplary recipients, however. The invention is applicable to greatly varying types of recipients.

The oxygen-generating unit according to the invention can therefore be used in particular to produce hydrogen peroxide and/or molecular oxygen dissolved in water. The oxygen thus produced can be used in a variety of applications.

For example, it can be provided that the oxygen-generating unit is used to supply a bioreactor for converting organic residues and/or waste materials into an organic nutrient solution using molecular oxygen dissolved in water. Such a bioreactor is described, for example, in published application DE 10 2017 131 089 A1 and can be designed in particular as described in the claims of the cited published application.

For example, it can alternatively or additionally be provided that the oxygen-generating unit is used to supply a device for converting ammonia from an aqueous liquid containing ammonia into molecular nitrogen using hydrogen peroxide and/or using molecular oxygen dissolved in water.

With the aid of the hydrogen peroxide and/or dissolved molecular oxygen generated by means of the photosensitive particles and the oxygen-generating unit, the effectiveness of a recipient can be increased, such as the effectiveness of the above-mentioned bioreactor or the conversion rate of ammonia to molecular nitrogen in the above-mentioned device for converting ammonia from an aqueous liquid containing ammonia into molecular nitrogen.

Such a device can in particular be designed as described hereinafter.

The device for converting ammonia from an aqueous liquid containing ammonia into molecular nitrogen can have units for circulating the liquid in a circuit, an inlet for feeding the liquid into the circuit, and a removal opening for removing the liquid from the circuit. The units of the circuit can comprise a cathode chamber, which has a cathode. The units can furthermore comprise an anode chamber for converting the ammonia into molecular nitrogen, wherein the anode chamber has an anode. The anode chamber can have a supply line for the circulating liquid, wherein the anode chamber can have a passage for the circulating liquid into the cathode chamber and wherein the cathode chamber can have a discharge line for the circulating liquid, which can be connected to the supply line of the anode chamber via a pump for pumping the circulating liquid. In such a device, the anode chamber and the cathode chamber belong to a common circuit. The liquid can be conducted continuously and multiple times through anode chamber and cathode chamber in this case. This enables continuous, environmentally-protective, and controlled ammonia conversion even at a low ammonia starting concentration and above all at a low final ammonia target concentration, wherein electrical energy is moreover generated during the ammonia conversion.

A discharge line of the oxygen-generating unit, such as the above-mentioned discharge line, can be connected to the above-mentioned inlet, for example. In this way, the oxygen-generating unit has a supply line to the circuit of the liquid containing ammonia, so that hydrogen peroxide and/or dissolved molecular hydrogen can be introduced into the ammonia-containing liquid circuit.

The anode chamber of the above-mentioned device is preferably designed to convert ammonia into nitrogen in operation. The cathode chamber can be designed in operation to emit the electrons coming from the anode to the cathode to the liquid with chemical participation of protons located in the liquid, molecular hydrogen, and/or hydrogen peroxide, which can be converted to water molecules. A catalyst, such as manganese oxide, for catalytic splitting of hydrogen peroxide, preferably into molecular oxygen and water, is preferably arranged in the anode chamber. A material of the cathode is preferably a catalyst for catalytic splitting of hydrogen peroxide into molecular oxygen and water, such as manganese dioxide. A material of the anode is preferably zinc.

### BRIEF DESCRIPTION OF THE DRAWINGS

The invention will now be described on the basis of a few exemplary embodiments, but is not restricted to these few exemplary embodiments. Further variants of the invention and exemplary embodiments result by combination of the features of individual or several claims with one another and/or with individual or several features of the exemplary embodiments and/or the above-described variants of devices and methods according to the invention.

In the figures:

FIG. 1 shows an exemplary embodiment of an oxygen-generating unit designed according to the invention, which is connected to a recipient of the generated oxygen,

FIG. 2 shows an exemplary embodiment of a photosensitive particle designed according to the invention,

FIG. 3 shows the recipient shown in FIG. 2 in a detail view.

### DETAILED DESCRIPTION

In the following description of various exemplary embodiments of the invention, elements corresponding in their function receive corresponding reference numbers even if the design or shape differs.

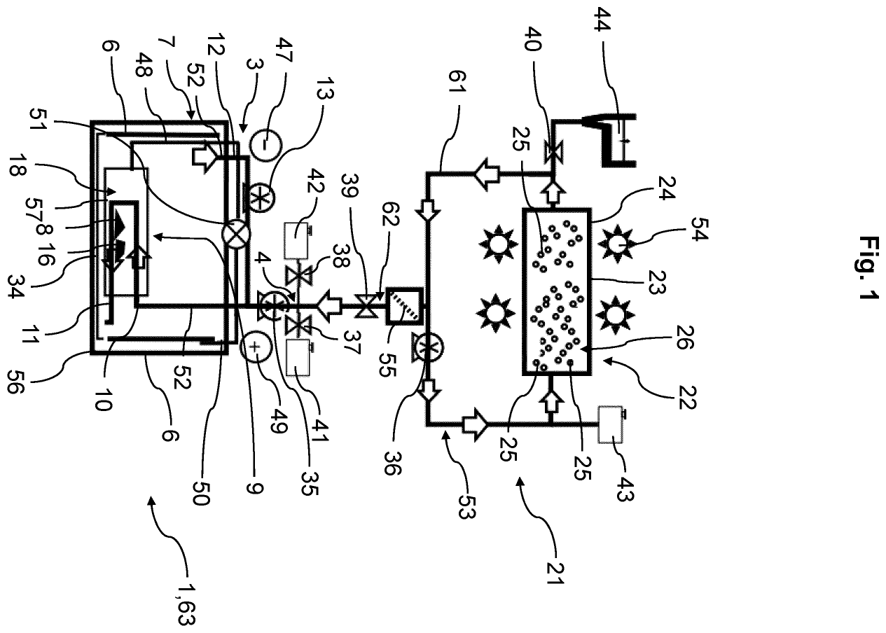

The oxygen-generating unit 21 shown in FIG. 1 has a photocell 22 having a hollow body 23, which has a wall 24 transparent to light in the spectrum of sunlight. A large number of photosensitive particles 25 are arranged in the hollow body 23.

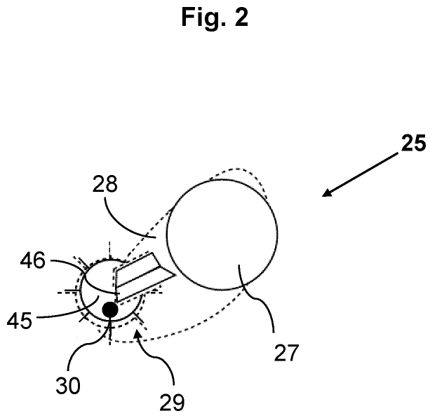

One such photosensitive particle 25 is shown in FIG. 2. The particle 25 has a carrier element 27, which can be a microplastic particle. The carrier element 27 is surrounded by an adhesive 28 comprising a mucilage, in which a material 29 is embedded that contains light-active pigment molecules 30. The light-active pigment molecules 30 are embedded in the exemplary embodiment shown in FIG. 2 in a complex made of humic substance 45 and clay mineral 46. Only one single complex 45, 46 and one light-active pigment molecule 30 are explicitly shown greatly enlarged and schematically in the figure. In reality, a very large number of humic substance molecules, clay mineral particles, and pigment molecules 30 are present. If such a photosensitive particle 25 is suspended in a photocell liquid 26, which can be water, an excitation of the light-active pigment molecules 30 can have the result that radicals form which release oxygen from the humic substance-clay mineral complex. Furthermore, the excitation of the pigment molecules 30 can have the result that the released oxygen is converted into hydrogen peroxide or that molecular oxygen is dissolved in the photocell liquid 26. These processes are described in more detail above.

The photocell 22 is integrated in an oxygen-generating circuit 53. The photocell liquid 26 can be set into circulation by means of a pump 36 and a line system, which forms a circuit and has at least one line 61. Photocell liquid 26 enriched with hydrogen peroxide and/or molecular oxygen can be discharged via the discharge line 62 connected to the oxygen-generating circuit 53, the filter 55, and the valve 39 from the oxygen-generating circuit 53.

The photocell liquid 26 absent in the oxygen-generating circuit 53 as a result of the discharge can be replaced by means of a tank 54, connected via a valve 40, which is filled with photocell liquid 26, preferably with water. Excess photocell liquid 26 enriched with hydrogen peroxide and with oxygen can alternatively also be conducted into a tank 43 for later use and temporarily stored there. Sunlight can be used as a light source 54. Alternatively, an artificial light source 54 can also be used, which generates light in a wavelength range suitable for the photocell 22.

Further variants of the oxygen-generating unit 21 and the photosensitive particles 25 and methods for producing the photosensitive particles 25 have been described above in detail.

The oxygen-generating unit 21 shown in FIG. 2 is connected to a recipient 63. For this purpose, the discharge line 62 of the oxygen-generating unit 21 is connected to an inlet 4 of the recipient 63.

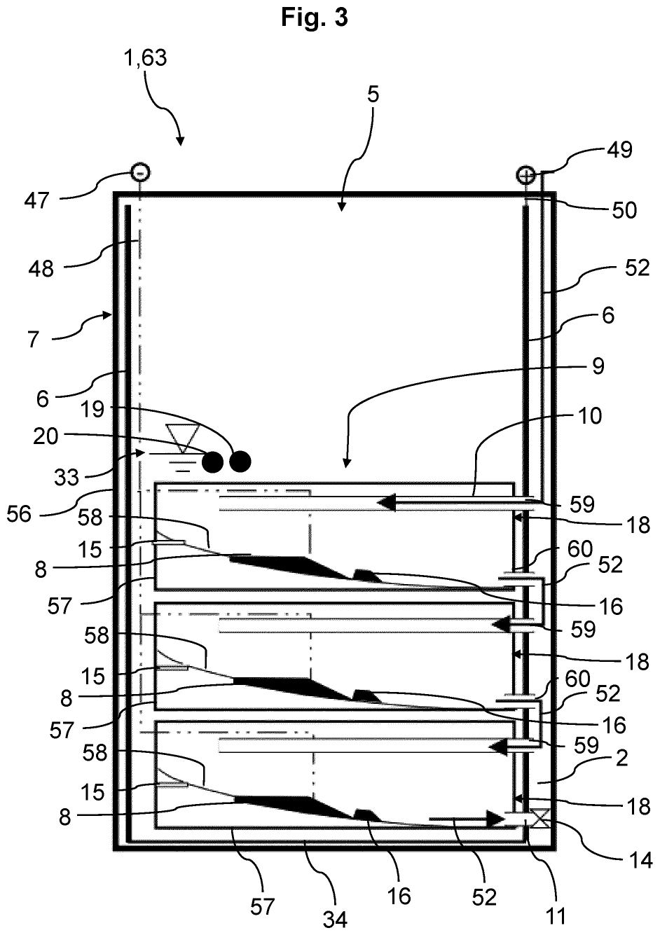

The recipient 63 can be designed in greatly varying ways. Two of the many options have already been described above. One of these applications is shown in FIG. 1, in which the recipient 63 is designed as a device 1 for converting ammonia from an aqueous liquid containing ammonia into molecular nitrogen. This device 1 is shown in more detail in FIG. 3, where it is shown in particular that a total of three anode chamber modules 18 connected to one another in series are arranged in the cathode chamber 7. Only one of the three anode chamber modules 18 is shown abstractly in FIG. 1, wherein only one such anode chamber module 18 can also be sufficient. The recipient 63 will be described in more detail hereinafter.

The aqueous liquid can be a residual liquid, such as a fermentation product from a biogas facility, the solid components of which have been largely separated.

The device 1 comprises a cathode chamber 7. The cathode chamber 7 has a container 56 having an impervious wall. The container 56 can be provided on top with a removable cover, so that a removal opening 5 for removing liquid 2 located in the container 56 can be formed on top.

The removal opening 5 can also be formed on the container 56 in that it has a drain which can be closable using a valve.

A cathode 6 having manganese dioxide as the cathode material is arranged in each case on both sides of the container 56 in the cathode chamber 7. The cathodes 6 are electrically connected to one another via an electrical connection 34.

The anode chamber 9 is arranged inside the cathode chamber 7, in particular inside the container 56 of the cathode chamber 7. The anode chamber 9 has multiple anode chamber modules 18, which are connected to one another in series. The anode chambers 18 each have a container 57 having an impervious wall. For the series connection, each anode chamber module 18, and in particular each container 57, has an inlet 59 and a discharge line 60. The discharge line 60 is connected to the inlet 59 of the respective closest anode chamber module 18 via a line.

A supply line 10 is connected to an inlet 59 of the first anode chamber module 18, so that liquid 2 can be conducted into the anode chamber 9. The discharge line 60 of the last anode chamber module 18 forms a passage 11 into the cathode chamber 7. Liquid 2 which is conducted via the supply line 10 into the anode chamber 9 therefore passes the individual anode chamber modules 18 in succession and enters the cathode chamber 7 at the passage 11 of the anode chamber 9.

The cathode chamber 7 is filled with the liquid 2 up to a fill level 33. The cathode chamber 7 has a discharge line 12, via which the liquid introduced from the anode chamber 9 into the cathode chamber 7 can be discharged again.

The discharge line 12 has a line connection via a pump 13 to the access 10 of the anode chamber 9, so that the liquid 2 can circulate in a circuit 3. A liquid flow 52 forming is shown in the drawings. The arrows indicate the flow direction. The pump 13 pumps the liquid 2 out of the cathode chamber 7 and into the anode chamber 9. The liquid 2 flows through the passage 11 back into the cathode chamber 7, where it is again pumped by the pump 13 into the anode chamber 9. When the valve 14 is open at the passage 11, a liquid circuit thus results, in which the liquid 2 passes through the device 1 multiple times.

An anode 8 is arranged in each of the anode chamber modules 18. Zinc is provided as the anode material. If the liquid 2 containing ammonia passes along the anodes 8, the ammonia reacts with hydroxide ions and forms water and molecular hydrogen. In addition, electrons are released, which travel to the cathode 6, which are electrically connected to one another with the anodes 8, which are electrically connected in parallel, via electrical lines 48, 50. The electrons can then react with molecular oxygen dissolved in the liquid 2 on the cathode 6 and water can be formed by the absorption of free protons.

The reactions on the anodes 8 and cathodes 6 thus result in a potential difference between anode 8 and cathode 6, so that electrical energy can be generated. A load 51 can be supplied with electrical energy using the generated electrical energy. The anode 8 forms a negative pole 47 here, while the cathode forms the positive pole 49.

Measuring sensors 19, 20, which are immersed in the liquid 2, are arranged in the cathode chamber 7. The measuring sensor 19 can be, for example, a measuring sensor 19 using which an oxygen concentration can be measured in the liquid 2. The measuring sensor 20 can be, for example, a measuring sensor 20 using which an ammonia concentration in the liquid 2 can be measured.

The anode chamber modules 18, in particular their containers 57, each have an outlet 15 opposite to the access 10 and the passage 11. The outlets 15 are dimensioned in such a way, in particular dimensioned sufficiently narrow, that in regular operation the amount of liquid flowing through the passage 11 into the cathode chamber 7 is multiple times greater than the total amount of liquid 2 which flows through all outlets 15 into the cathode chamber 7. The outlet 15 is arranged farther upward in an anode container 57 than the respective discharge line 60. The outlets 15 are arranged directly at the cathode 6, so that hydrogen peroxide or molecular oxygen, which flows through an outlet 15, can reach the cathode 6 immediately and directly.

The outlets 15 are important above all during the initialization of the device 1. The device 1 has an inlet 4, using which the liquid 2 can be added to the circuit 3. A tank 41 is filled with the liquid 2, which has an ammonia starting concentration of, for example, 800 mg/L. The tank 41 has a line connection to the inlet 4, wherein the supply line is closable by a valve 37. For the initialization of the device 1, the cathode chamber 7 is filled up to the fill level 33 with valve 37 open. The valve 37 is then closed.

A tank 42 filled with hydrogen peroxide can be provided as an auxiliary in addition to the oxygen-generating device 21 for supplying the recipient 63 with hydrogen peroxide. The tank 42 has a line connection to the inlet 4 via a valve 38, which can be actuated to supply the recipient 63 alternatively to the valve 39, wherein photocell liquid 26 enriched with hydrogen oxide can be introduced from the oxygen-generating unit 21 into the circuit 3 of the device 1 via the valve 39. The valve 39 or 38 is initially closed. After filling the cathode chamber 7 with the liquid 2, the valve 14 is closed and the valve 39 or 38 is opened, so that hydrogen peroxide flows via the inlet 4 and the supply line 10 initially into the first anode chamber module 18 of the anode chamber 9 by means of switched-on pump 35. A contact surface of a catalyst 16 made of manganese dioxide is located on an inclined intermediate floor 58 in each anode chamber module 18. The hydrogen peroxide is catalytically converted into molecular hydrogen by the manganese dioxide. The volume increases very strongly here, since hydrogen peroxide is liquid and molecular oxygen is gaseous. The pressure in the anode chamber module 18 rises and the oxygen is pressed out of the outlet 15 and conducted to the cathode 6. Hydrogen peroxide can also be entrained in this case and in this way reaches the cathode 6 directly via the outlet 15. The oxygen content in the liquid 2 can be measured using the oxygen concentration measuring sensor 19. As soon as a desired concentration is reached. If this concentration is reached, the initialization phase is completed and the device 1 can be operated in the regular operating mode.

In the regular operating mode, the valves 37, 38, 39 have been or are closed and the valve 14 is opened. The pump 13 is activated, so that the liquid 2 begins to form a liquid flow 52 and to circulate through the device 1 in the circuit 3. The reactions at anode 8 and cathode 6 begin. The high initial oxygen concentration at the cathode 6 and the oxygen recycling due to the manganese dioxide used as the cathode material have the result that the ammonia conversion rate rapidly reaches a high operating value. The molecular nitrogen formed can escape upward through a venting option in the cathode chamber 7 into the atmosphere or can be collected in another way, for example.

The oxygen concentration can be checked by means of the sensor 19 in regular operation. If it sinks below a critical value, the valve 39 or 38 can be opened so that hydrogen peroxide and possibly dissolved molecular oxygen is added to the further circulating liquid 2 via the inlet 4.

The invention relates to a photosensitive particle 25 having a carrier element 27, on which a material 29 adheres by means of an adhesive 28, wherein the material 29 contains light-active pigment molecules 30. A large number of such photosensitive particles 25 can be arranged in a photocell 22 of an oxygen-generating unit 21.

### LIST OF REFERENCE SIGNS

1 device
2 liquid
3 circuit
4 inlet
5 removal opening
6 cathode
7 cathode chamber
8 anode
9 anode chamber
10 supply line
11 passage
12 discharge line
13 pump
14 valve
15 outlet
16 catalyst
18 anode chamber module
19 measuring sensor
20 measuring sensor
21 oxygen-generating unit
22 photocell
23 hollow body
24 wall
25 photosensitive particle
26 photocell liquid
27 carrier element
28 adhesive
29 material
30 light-active pigment molecules
33 fill level
34 electrical connection
35 pump
36 pump
37 valve
38 valve
39 valve
40 valve
41 tank
42 tank
43 tank
44 tank
45 humic substance
46 clay mineral
47 negative pole
48 electric line
49 positive pole
50 electric line
51 load
52 liquid flow in 3
53 oxygen-generating circuit
54 light source
55 filter
56 container of 7
57 container of 18
58 intermediate floor in 57
59 inlet of 18
60 discharge line of 18
61 line
62 discharge line
63 recipient

1. A photosensitive particle (25) comprising:
a carrier element (27), on which a material (29) adheres via an adhesive (28); and
the material (29) contains light-active pigment molecules (30).

2. The photosensitive particle (25) as claimed in claim 1, wherein the material (29) comprises a nonliving organic substance (45, 46), including at least one of a humus component (45) or a clay mineral (46).

3. The photosensitive particle (25) as claimed in claim 1, wherein the material (29) comprises plant leaf polymers.

4. The photosensitive particle (25) as claimed in claim 1, wherein the light-active pigment molecules (30) are sensitive in a spectrum of sunlight.

5. The photosensitive particle (25) as claimed in claim 1, wherein the carrier element (27) has a maximum diameter of 1 cm.

6. The photosensitive particle (25) as claimed in claim 1, wherein the carrier element (27) is made of a plastic.

7. The photosensitive particle (25) as claimed in claim 1, wherein the adhesive (28) comprises a mucilage.

8. The photosensitive particle (25) as claimed in claim 1, wherein the adhesive (28) envelops the carrier material (27).

9. An oxygen-generating unit (21), comprising:
a photocell (22) including a large number of photosensitive particles (25) as claimed in claim 1.

10. The oxygen-generating unit (21) as claimed in claim 9, wherein the photocell (22) has a hollow body (23) having a transparent wall (24).

11. The oxygen-generating unit (21) as claimed in claim 10, wherein the photosensitive particles (25) are suspended in a photocell liquid (26) containing water.

12. The oxygen-generating unit (21) as claimed in claim 11, further comprising an oxygen-generating circuit (53) for the photocell liquid (26), and the photocell (22) is incorporated in the oxygen-generating circuit (53).

13. The oxygen-generating unit (21) as claimed in claim 12, further comprising at least one of a) a tank (44) connected to the oxygen-generating circuit (53), that is adapted to feed the photocell liquid (26) into the oxygen-generating circuit (53), or b) a discharge line (62) connected to the oxygen-generating circuit (53), via which the photocell liquid (26) is adapted to be discharged.

14. A method for producing the photosensitive particle (25) as claimed in claim 1, the method comprising:
Applying the material (29) containing the light-active pigment molecules (3) to the carrier element (27) via the adhesive (28).

15. The method as claimed in claim 14, further comprising producing the carrier element (27) by pulverizing macroplastic.

16. The method as claimed in claim 14, wherein a mucilage is used as the adhesive (28), which is produced by taking human, animal, or plant mucus or by chemically producing the mucilage.

17. The method as claimed in claim 14, wherein the material (29) which contains the light-active pigment molecules (30) is obtained by at least one of isolating or providing nonliving organic substance.

18. The method as claimed in claim 17, wherein to provide the organic substance, the method further comprises providing plant leaf material containing plant leaf polymer having at least one of a plant pigment proportion that is at least 1%, a lignin mass proportion that is greater than 1% in dry substance, or a mass proportion of a chlorophyll degradation product non-fluorescent chlorophyll catabolites (NCC) that is between 0.6% and 1.2% in dry substance of a total proportion of the plant leaf material.

19. The method as claimed in claim 18, wherein the plant leaf material is dried until a water mass proportion of the plant leaf material of at most 25% is achieved.

20. The method as claimed in claim 19, further comprising mixing the plant leaf material with clay minerals such that a mass proportion of the plant leaf material is between 60% and 99%, and a mass proportion of the clay minerals is between 1% and 20%, and a mass proportion of water and a further material is between 0% and 20%.

21. The method as claimed in claim 14, further comprising mixing the material (29) containing the light-active pigment molecules (30) with the adhesive (28) to form a material-adhesive mixture, wherein the material has a mass proportion between 80% and 99%, and the adhesive has a mass proportion between 1% and 10%.

22. The method as claimed in claim 21, further comprising mixing the material-adhesive mixture with the carrier elements (27), so that the carrier elements (27) are enveloped by the adhesive (28), such that an outer surface of the envelope is at most 10% larger than a surface of the enveloped carrier element (27).

23. A method for generating oxygen, comprising:
providing the oxygen-generating unit (21) as claimed in claim 9; and
operating the oxygen generating unit to produce at least one of hydrogen peroxide or molecular oxygen dissolved in water.

24. The method as claimed in claim 23, further comprising supplying the at least one of the hydrogen peroxide or the molecular oxygen dissolved in water to at least one of a device (1) for converting ammonia from an aqueous liquid containing ammonia into molecular nitrogen or a bioreactor for converting organic residues and/or waste materials into an organic nutrient solution are.
